(19) United States
(12) Patent Application Publication
(10) Pub. No.: US 2026/0195577 A1
(43) Pub. Date: Jul. 9, 2026

(54) QUANTIZATION FOR PERFORMING OPERATIONS OF MACHINE LEARNING MODELS

(71) Applicant: Black Sesame Technologies Inc., San Jose, CA (US)

(72) Inventors: Mingxiang Wang, Milpitas, CA (US); Yi Wang, San Jose, CA (US)

(21) Appl. No.: 19/012,647

(22) Filed: Jan. 7, 2025

(51) Int. Cl. G06N 3/0495; G06N 3/048

(52) U.S. Cl. CPC G06N 3/0495; G06N 3/048

(57) ABSTRACT

Methods, systems, and apparatuses, including computer programs encoded on computer storage media, for performing operations represented by a neural network comprising a plurality of neural network layers. The methods comprise receiving a computation result of a multiplication operation between nodal inputs to a network layer of the neural network and corresponding nodal weights of the network layer. The computation result is of a first precision. The computation result is processed using a particular activation function to generate a layer output. The layer output is of a second precision that is lower than the first precision. The particular activation function is determined based on a quantization process using a power value other than the multiples of two. The particular activation function generates a non-zero output when the computation result is non-zero. A neural network output is generated for a corresponding network input based on the layer output.

### BACKGROUND

This specification relates to quantization operations for efficiently performing operations represented by a machine learning model, particularly applying quantization techniques to efficiently perform nodal computations of a neural network.

Neural networks are machine learning models that employ one or more layers of nonlinear units to predict an output for a received input. Some neural networks include one or more hidden layers in addition to an output layer. The output of each hidden layer is used as input to the next layer in the network, i.e., the next hidden layer or the output layer. Each layer of the network generates an output from a received input in accordance with current values of a respective set of parameters.

### SUMMARY

This specification describes techniques for efficiently performing nodal operations of one or more layers in a neural network using one or more quantization techniques. In particular, the described techniques generally relate to using a particular activation function for one or more nodes of one or more network layers in a neural network. The particular activation function first includes a quantization scheme that is based on powers that are not two (i.e., non-power-of-two (NPOT) quantization) over the nodal inputs. The described techniques can reduce the computation cost, memory usage, and power consumption for performing operations of a trained neural network at the inference stage, while maximizing the utilization of the range of values representable by a particular data structure and meeting the particular precision requirement. In addition, the particular activation function further includes a particular parametric ReLU function infused with the NOT quantization such that both the NPOT quantization scheme and the parametric ReLU function can form a combined quantization scheme for nodal operations. Such a quantization scheme can further improve the efficiency of performing neural network operations without significantly increasing the number and the types of algebraic operations, memory usage, and power consumption for performing nodal operations of network layers. Moreover, the described techniques can also include one or more global parameters or coefficients to modify the particular activation function such that the described techniques can turn on and turn off the NPOT quantization function and/or the parametric ReLU function according to the different requirements of using the neural network.

One aspect of the subject matter described in this specification can be embodied in a method that includes operations for performing operations represented by a neural network comprising a plurality of neural network layers. The method includes receiving a computation result of a multiplication operation between nodal inputs to a network layer of the neural network and corresponding nodal weights of the network layer. The computation result is of a first precision.

The method further includes processing the computation result using a particular activation function to generate a layer output. The layer output is of a second precision that is lower than the first precision. The particular activation function is determined based on the NPOT quantization scheme and the parametric ReLU function. To generate the layer output, the method further includes performing at least one of a pre-shift operation, a post-shift operation, a rounding operation, a clip operation, a cut-off operation, an add-shift operation, or other suitable operations.

Other embodiments of this aspect include corresponding computer systems, apparatus, computer program products, and computer programs recorded on one or more computer storage devices, each configured to perform the actions of the methods. A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by a data processing apparatus, cause the apparatus to perform the actions.

Particular embodiments of the subject matter described in this specification can be implemented to realize one or more of the following advantages. The described techniques can improve the efficiency and robustness of performing operations of a neural network while satisfying a particular accuracy set forth by the requirements of using the neural network.

In general, a quantization scheme can be applied for nodal operations (e.g., by using a particular activation function) to reduce the number of significant digits for presenting a numerical value generated from the nodal operations of one or more nodes in one or more layers of a neural network. Quantization schemes generally reduce the computation cost and memory usage for performing operations of a neural network, particularly for deep neural networks with millions and even billions of model parameters, at the cost of reduced accuracy of numerical values due to using fewer significant digits. However, such a cost of reduced accuracy can be neglectable for situations where the quantized values are accurate enough according to corresponding requirements.

Compared to conventional quantization schemes, the described techniques can further improve the efficiency of performing operations of neural networks. More specifically, conventional quantization schemes or operations generally have a scale factor that is a multiple of two (e.g., 2, 4, 8, etc.). A scale factor is generally used to reduce the range of representable values for a particular data structure or type. For example, a group of integer values ranging from −100 to 100 can be represented using a signed 8-bit integer data type or formatting (i.e., INT8) since INT8 can represent values between −128 and 127. However, for values ranging from −100 to 100 in this example, the representable values of INT8 that range from −128 to −101 and the range from 101 to 127 of INT8 would never be used, which is generally a waste of representable ranges. Since the ratio between 128 and 100 is 1.28, which is greater than 1 but smaller than 2, one cannot simply use a power-of-two quantization to map the integer values to a data type with one bit fewer size (i.e., a signed 7-bit integer data type or formatting or INT7), which can only represent values between −64 to 63 and does not cover the entire range of possible values from −100 to 100.

To resolve this issue, the described techniques implement a quantization scheme based on a scale factor that is not a power of two (NPOT), e.g., a scale factor ranging from one to two (i.e., [1,2)), to map values from a current range to a range representable by a pre-determined data type or formatting. In addition, before performing the NPOT quantization scheme operations, the described techniques can further perform bias operations to improve data symmetry and shift operations before or after the NPOT quantization scheme operations to reduce data sizes, which can further enhance the computation efficiency and reduce the computation cost for performing neural network operations.

Note that the integer data type or formatting can be used to represent non-integer values in accordance with data that represent the position of the decimal point. Data representing the position of decimal points can be calculated during computations and stored in a memory unit. Other numbers of bits and types of formatting or data types can be used according to different computation requirements. For example, the formatting size can include 8-bit, 10-bit, 12-bit, 16-bit, 24-bit, or other suitable sizes, and the data type or formatting can include various floating point formats and integer formats according to different formatting requirements.

A system implementing the described techniques can further improve the efficiency of performing operations of a neural network by infusing a parametric ReLU function with a particular nodal quantization scheme (e.g., the nodal activation functions using the NPOT quantization scheme), as described above. The parametric ReLU function is advantageous over a regular ReLU function since the parametric ReLU function includes an adjustable slope (also referred to as a “second coefficient” below) for the third quadrant. The adjustable slope is generally non-zero and, thus, is learnable while training the neural network using training samples. In addition, the parametric ReLU function can also improve the convergence in the training process since even a small gradient in the third quadrant can help stabilize the backpropagation process at the training stage. Furthermore, the parametric ReLU function can improve output accuracy by mitigating dead neurons (i.e., neurons or nodes generating only zero outputs for all inputs). In addition, the combination of the parametric ReLU function with the quantization scheme for one or more nodes of one or more layers does not significantly increase the number of computations needed to perform the operations of the neural network. Nor does it change the types of computation and/or require new types of computations for performing the operations represented by the neural network. Rather, the parametric ReLU function essentially relates to one or more multiply operations, which mainly share the same type of operations needed for the quantization operations to reduce computation cost and memory usage. Since the described techniques implementing the quantization operations already introduce additional multiply operations for quantization anyway, infusing the parametric ReLU function with nodal NPOT quantization operations accordingly does not increase much of the computational cost.

In addition, the described techniques are robust to different neural networks with various structures. More specifically, the described techniques include one or more global parameters or coefficients that are adjustable to modify the nodal activation function such that the NPOT quantization scheme and/or the parametric ReLU function can be turned on and off according to different requirements for performing operations of a neural network. For example, by turning off one or more global parameters or coefficients, the described NPOT quantization scheme and parametric ReLU function can be configured to represent only a leaking ReLU function. As another example, the described quantization scheme and parametric ReLU function can be configured to represent a single NPOT quantization scheme by, e.g., turning off a first coefficient that is associated with the adjustable slope.

Moreover, the described techniques are robust to different input data from different channels. More specifically, the described techniques can include various add-shift operations to ensure accuracy and consistency across data generated through different channels in different layers.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 illustrates an example quantization system configured to process input data using a particular activation function.

FIG. 2A illustrates an example of value distribution.

FIG. 2B illustrates another example of value distribution.

FIG. 3A illustrates an example activation function using a particular quantization scheme and the parametric ReLU function.

FIG. 3B illustrates an example non-power-of-two quantization scheme derived from the example activation function of FIG. 3A.

FIG. 3C illustrates an example standard ReLU function derived from the example activation function of FIG. 3A.

FIG. 4 illustrates an example sequence of operations performed by the example quantization system of FIG. 1.

FIG. 5 illustrates an example inter-layer structure of a neural network that includes one or more add channels.

FIG. 6 is a flow diagram of an example process for processing input data using a particular activation function.

Like reference numbers and designations in the various drawings indicate like elements.

### DETAILED DESCRIPTION

The described techniques relate to quantization operations for performing nodal operations of one or more network layers in a neural network. In general, nodal operations of a network layer in a neural network generally include add operations and multiply operations. The described techniques improve the efficiency and reduce the computation and memory cost of performing nodal operations in a network layer by implementing a non-power-of-two (NPOT) quantization. More specifically, the NPOT quantization scheme relates to mapping one or more computation results stored in a first formatting with a higher precision (e.g., using more significant figures or using formatting with a greater data structure size or with a higher capacity) to a second formatting with a lower precision (e.g., using fewer significant figures or using formatting with a smaller data structure size or with a lower capacity) according to a scale value that is greater or equal to one and less than two. Although the NPOT quantization scheme can increase the number of multiply operations for performing the nodal operations of network layers since it can introduce additional multiply operations to the original neural network operations, the NPOT quantization scheme reduces the overall computation cost and memory usage due to value representation using data types or formattings with lower accuracy.

To further leverage the advantages of NPOT quantization operations, the described techniques implement particular nodal operations for one or more nodes in one or more layers other than the standard ReLU function. As an example, the particular nodal operations can include a leaky ReLU or a parametric ReLU function. The particular nodal operations could further improve the accuracy and convergence for performing nodal operations of network layers since the leaky ReLU function and the parametric ReLU function have non-zero first-order derivatives, which improves convergence during the backward propagation of the training process.

That said, the particular nodal operations, such as the leaky ReLU function or parametric ReLU function, could introduce additional multiply operations for performing the nodal operations of the neural network, yet the overall effect due to the additional operations on the computation and memory usage is minimal or negligible partly because the additional operations are multiply operations, which are of the same type as the additional operations introduced by the NPOT quantization scheme. Note that, in terms of computation cost and memory usage, multiply operations are generally preferred over add (or subtract) operations in operations represented by a neural network.

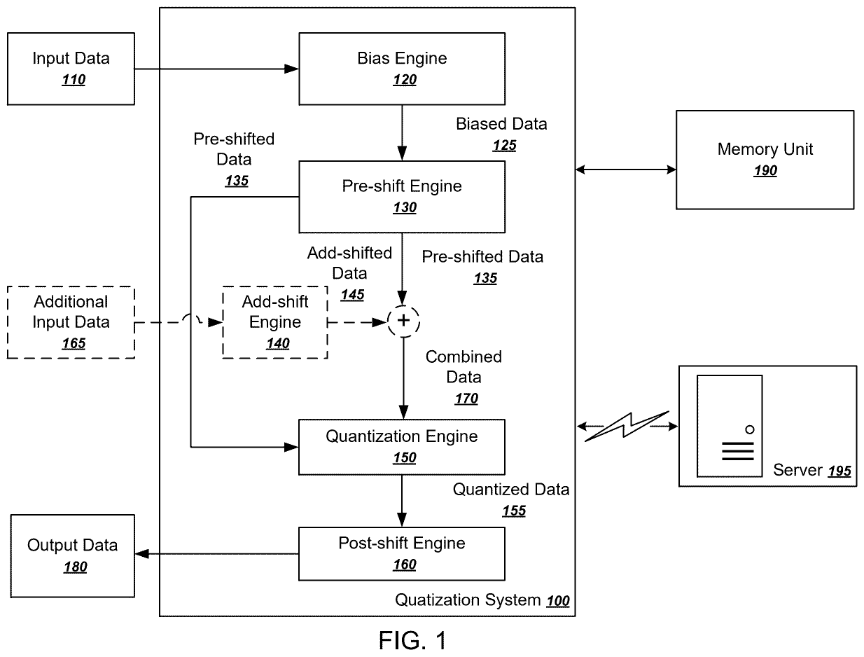

FIG. 1 illustrates an example quantization system 100 configured to process input data 110 using a particular activation function. In general, the quantization system 100 can be implemented on one or more computers or processors at one or more locations. The one or more computers or processors can be coupled with one another wirelessly or by wires. The one or more computers or processors can include one or more CPUs, GPUs, TPUs, or other suitable types of processors. For simplification, the quantization system 100 is also referred to as system 100 in the following description.

As shown in FIG. 1, system 100 can include one or more engines to process input data 110 and generate output data 180. The input data 110 generally includes one or more computation results based on nodal inputs and nodal weights for one or more nodes in one or more layers of a neural network. For example, the computation result can include a multiplication result of a nodal input and a nodal weight(s) for a node in a layer. The nodal input to a corresponding node in the current layer can be a nodal output(s) (e.g., a scalar, vector, or matrix of nodal output(s)) from a node in a previous layer that immediately precedes the current layer, and the nodal weight can be a weight(s) (e.g., a scalar, vector, or matrix of weight(s)) associated with the corresponding node. In some implementations, the computation result can be a sum of one or more multiplication results. For example, for a vector of nodal inputs multiplying a matrix of nodal weights for nodes in a layer, the multiplication result is in a vector form and the computation result is the sum of the multiplication result vector.

The input data 110 can be stored in a data type or formatting with a first precision. For example, the input data 110 can be stored as integer types, e.g., (signed or unsigned) INT12 integer, INT14 integer, INT16 integer, INT24 integer, or other suitable integer types. Note that input data 110 can also be stored in a floating type or formatting with a particular size according to different computation requirements.

The computation result of the input data 110 is further provided as input to one or more nodal activation functions of the current nodes in the current layer. The nodal activation functions generally perform nonlinear transformation over the computation result before the computation result is provided as output from the current nodes to corresponding nodes in the immediately succeeding layer of the neural network.

In some implementations, the input data 110 can include nodal inputs and corresponding nodal weights of the current layer. The quantization system 100 can include a multiplication unit configured to process the nodal input and the nodal weights by multiplying them (and optionally summing them) to generate the computation result. For a particular hardware, the nodal output data and the nodal weights can be stored and received by the multiplication unit/or the quantization system 100 in a first size (e.g., bit width) with a first precision (e.g., INT8 with 8 bits), and the computation result can be stored in a second size (e.g., bit width) with a second precision (e.g., INT16 with 16 bits or INT24 with 24 bits). For simplicity and ease of illustration, the input data 110 described below, by default, refers to a computation result based on nodal weights and nodal inputs for the current layer.

Output 180 generally includes nodal output from the nodal activation functions of corresponding one or more nodes in the current layer. The output from the nodal activation functions is also referred to as the nodal output from the corresponding one or more nodes of the current layer. The output 180 is then provided as input for one or more nodes in the succeeding layer of the neural network.

For a particular hardware or computation unit, the output data 180 is stored by data types having the same level of precision as the input data 110. For example, for situations where the quantization system 100 has a multiplication unit, the input data include nodal weights and corresponding nodal inputs with a data size of 8 bits (e.g., INT8 or UINT8), and the output data accordingly has the same size of 8 bits (e.g., INT8 or UINT8). However, in some cases where the input data include computations results generated by the nodal inputs and nodal weights for the current layer, the input data can be stored in a data type or formatting with a greater size with a higher precision (e.g., INT16 or INT24), and the output data 180 can be stored in a data type or formatting with a lower precision (e.g., INT8 or UINT8). Note that output data 180 can be stored in an integer type, a floating type, or other suitable types with a particular size according to different computation requirements or hardware designs.

System 100 can include a bias engine 120 configured to process input data 110 by performing bias operations over the input data 110 to generate biased data 125. The bias engine 120 first determines whether to perform one or more bias operations of input data 110 according to one or more criteria. One or more criteria can include at least one of whether input data 110 has a symmetric value distribution or whether input data 100 has a mean or median that is away from a predetermined value (e.g., zero, a non-zero positive value, etc.). In response to determining that input data 110 has an asymmetric value distribution and/or the mean or median of input data 110 is away from the predetermined value, the bias engine 120 performs one or more bias operations to bias input data 110 according to a bias value. The bias value is determined based on a distribution of all possible values in input data 110. For example, for a computation result of input data 110, the bias value is determined on the probability distribution of all values for the computation result from computations based on the corresponding nodal input(s) and nodal weight(s).

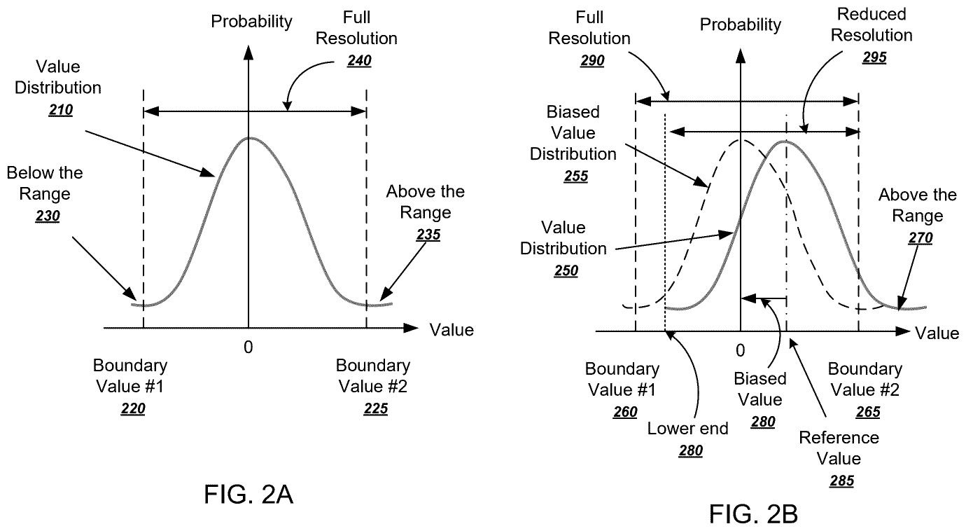

As a more concrete example, FIG. 2A illustrates an example of value distribution 210, representing possible values of each of input data 110 (or corresponding computation results) with a corresponding possibility. The value distribution 210 is roughly symmetric at the axis where the probability equals zero. The horizontal axis in FIG. 2A represents a value for the input data (or the computation result), and the vertical axis represents a probability for a particular value. Thus, according to FIG. 2A, values close to zero have the highest probability, and the farther the values are away from zero, the lower the probabilities are for those values. The term “roughly symmetric” in this specification generally distinguishes the term “symmetric” in that no strict symmetry is required for rough symmetry. As shown in FIG. 2A, although the value distribution 210 is not strictly symmetric around the axis where the probability equals zero, the mean or median value of value distribution 210 is zero with the highest possibility, and the possibilities are roughly mirrored on both sides of the axis where the probability equals zero.

In addition, value distribution 210 represents the probabilities of values that fall within and outside a region between boundary value #1 (220) and boundary value #2 (225). Values that fall outside the region are those with values below the range 230 (i.e., less than the boundary value #1 (220)) and values that are above the range 235 (i.e., greater than the boundary value #2 (225)). Since value distribution 210 is roughly symmetric with a mean/median value of zero, the possible values of value distribution 210 roughly span the full resolution 240 of the region. In other words, most values of the value distribution 210 are covered inside the region, which is preferrable since the data structure used for representing values in the region between the boundary value #1 (220) and boundary value #2 (225) can be fully utilized, improving the efficiency and usage of data structures and the memory. The bias value and the biased data 125 should have the same data type or formatting as the computation result (e.g., input data 110) based on nodal weights and nodal inputs for the current layer. Accordingly, the bias value and the biased data 125 can be represented by data types or formatting, including integers (e.g., INT12, INT16, INT24, etc.), floating types, or other suitable data types or formatting.

In general, system 100 can represent a floating-type value using an INT data type or formatting. More specifically, system 100 can use an INT data type to represent significant digits in the floating-type data and store data representing a location of the decimal point, an exponent part, or both, which can be stored in one or two bits in the INT data type or in a memory unit 190 of the system 100.

FIG. 2B illustrates another example of value distribution 250. Similar to value distribution 210, value distribution 250 represents each possible value of input data 110 (or corresponding computation results) with a corresponding possibility. However, the probability distribution of value distribution 250 is roughly symmetric at the axis of reference value 285, e.g., a mean, median, or expectation of all possible values of value distribution 250. The reference value 285 is greater than zero by the biased value 280. The biased value 280 is determined based on a difference between the reference value 285 and a value at which the value distribution 250 is roughly symmetric. In this case, even if the value distribution 250 looks roughly symmetric around the axis of reference value 285, it is not roughly symmetric around the value of zero. Accordingly, value distribution 250 only spans a portion of the full range of representable values in a region between boundary value #1 (260) and boundary value #2 (270). According to FIG. 2B, the full range of the representable values is also referred to as full resolution 290, and the portion of the full range of representable values spanned by the value distribution 250 is also referred to as reduced resolution 295.

To improve the utilization of the full resolution 290, the bias engine 120 is configured to determine whether input data 110 (or the computation result based on nodal weights and nodal inputs for the current layer) needs to be biased based on one or more criteria. The one or more criteria include at least one of whether a value distribution of input data 110 is roughly symmetric, or whether the mean or median of the value distribution is away from a predetermined value (e.g., zero). In response to determining that input data 110 satisfies one or more criteria, the bias engine 120 can shift all values in input data 110 (and corresponding computation results) by adding or subtracting a biased value determined based on the value distribution. Here in FIG. 2B, bias engine 120 is configured to bias input value 110 by shifting all values in the input value 110 to the left by the biased value 280. This way, the biased value distribution 255 becomes roughly symmetric around the value of zero, and the system can use the full resolution 290 to represent most of the possible values of the biased value distribution 255.

The bias engine 120 is configured to generate biased data 125 by biasing the input data 100 based on the bias value 280. When the bias engine 120 determines that it should not perform bias operations on input data 110, the bias engine 120 can directly provide the input data 100 as output. Thus, for simplicity, bias data 125 generally refers to output data generated from the biased engine 120, which does not necessarily refer to data that has been biased by the bias engine 120.

Referring back to FIG. 1, system 100 includes a pre-shift engine 130 to reduce the size of biased data 125 output from bias engine 120. In general, pre-shift engine 130 is configured to perform a pre-shift operation over the biased data 125 to generate pre-shifted data 135 with a data size smaller than the biased data 125. The pre-shifted data 135 accordingly has a precision lower than that of input data 110 and biased data 125. The pre-shifted data 135 can be represented by data types that are one-bit, two-bit, five-bit, ten-bit, twelve-bit, or other number bits smaller in size than those of input data 110 or biased data 125. For example, input data 110 or biased data 125 can be represented by INT24, and the pre-shifted data 135 can be represented by INT12, INT11, or other suitable data types or formatting. The pre-shifted data 135 is also referred to as intermediate results in the description below.

The pre-shift operations performed by the pre-shift engine 130 generally relate to reducing the data size or precision by removing the lower digits in the corresponding data type or formatting. For example, the pre-shift operations can reduce a 24-bit data type to a 12-bit data type by removing the lower 12-bit information from the 24-bit data type. The pre-shift operations can also be referred to as the standard quantization operations with the power of two. Note that the pre-shift operations do not include the NPOT quantization scheme and the parametric ReLU function as described above. However, pre-shift operations are generally beneficial since they reduce the data sizes (or bit width) and memory usage for performing operations in the NPOT quantization scheme and the parametric ReLU function.

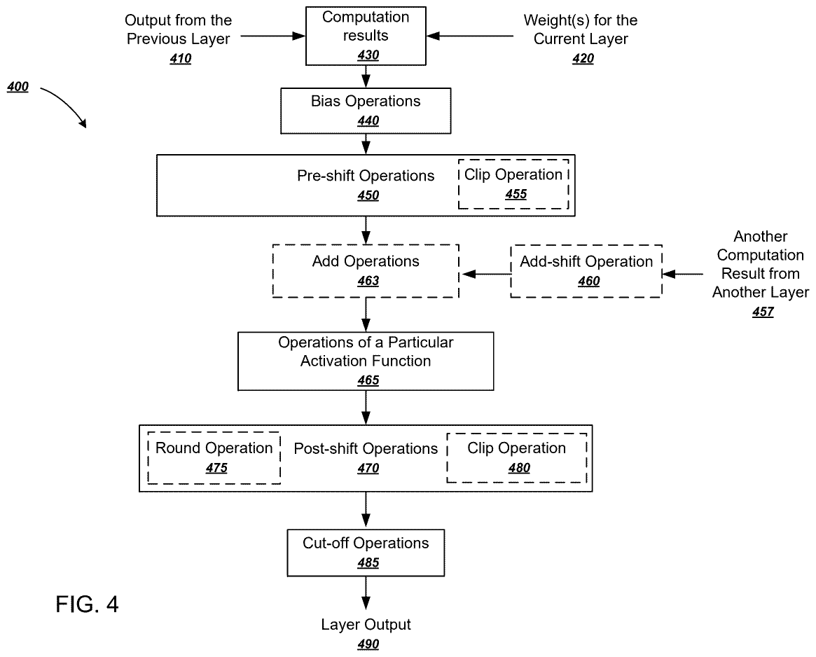

To generate the pre-shifted data 135, the pre-shift engine 130 is further configured to perform a clip operation to change values located outside the reduced range to a corresponding boundary value. For example, for a range of [−1000, 999], the pre-shift engine 130 is configured to change the value of 1001 to value 999 since the value of 1001 is located outside the range and the value 999 is the corresponding boundary value (e.g., the closest boundary value). The pre-shift engine 130 is configured to add a value of 999 to the group of values since 1001 is closest to the upper boundary (i.e., 999). More details of operations performed by the pre-shift engine 130 are described below in connection with FIG. 4. The pre-shifted data 135 is then processed by the quantization engine 150. More details of the quantization engine 150 are described immediately below.

In some implementations where the current network layer is coupled with another network layer (e.g., at least a portion of the output of the current network layer is to be summed with a portion of the other network layer), system 100 can include an add-shift engine 140 to further align decimal points of nodal outputs from the current network layer and nodal outputs of the other network layer before combining them. More specifically, the add-shift engine 140 is configured to determine whether the other layer is an add layer including an add channel. The add layer generally relates to a network layer where the output of the add layer is configured to be added by the output of the current network output before the combined output is processed by corresponding nodal activation functions. The add channel includes one or more nodes, of which the nodal output is to be added with a corresponding add channel in the current network layer.

In response to determining that the other network layer is an add layer including an add channel, add-shift engine 140 is configured to shift the decimal point of output from the add channel of the add network layer (e.g., additional input data 165) to align with the decimal point of the output of the current network layer (e.g., pre-shifted data 135). For example, to align the decimal points, the add-shift engine 140 can be configured to shift the position of the decimal points of the additional input data 165 by 1 bit, 2 bits, 3 bits, or other suitable numbers of bits to generate add-shifted data 145. In some situations where the decimal points of the add layer output and the current layer output are already aligned, the add-shift engine 140 accordingly does not shift the decimal point of the add layer. In these situations, the additional input data 165 has the same decimal point position as the add-shifted data 145.

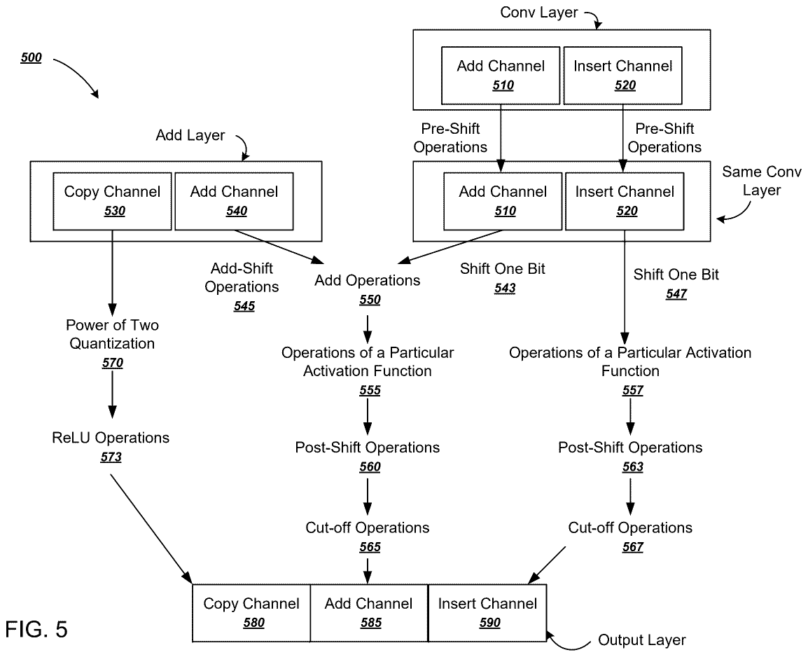

Once the decimal points are aligned, the quantization system 100 is configured to add the output from the two add channels of two layers to generate combined data as input for the quantization engine 150. As shown in FIG. 1, the pre-shifted data 135 and the add-shifted data 145 are combined or added together to generate combined data 170, and the combined data 170 are then provided to the quantization engine 160 for further processing. More details of the add-shift operations performed by add-shift engine 140 are described below in connection with FIG. 5.

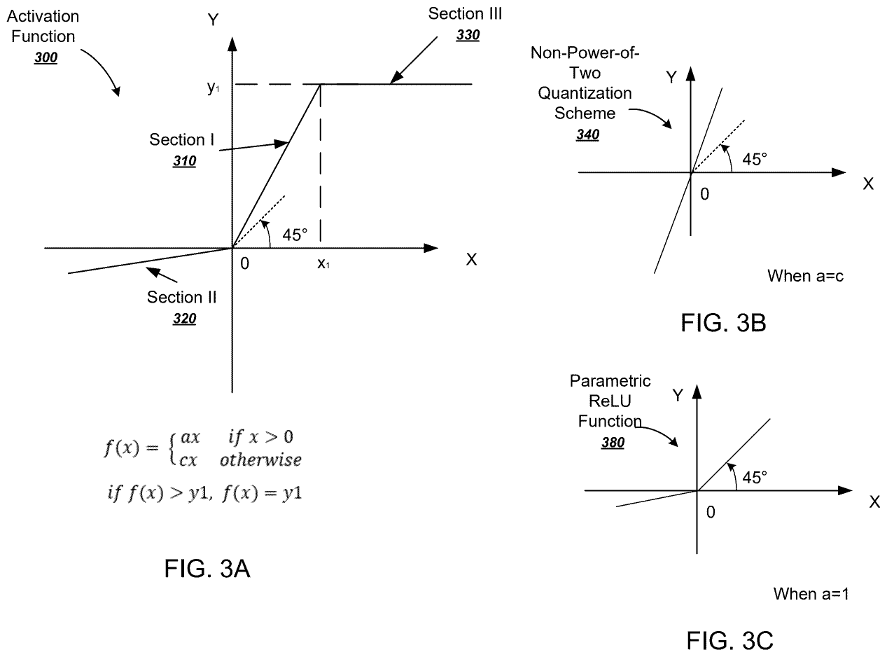

The quantization system 100 further includes a quantization engine 150 configured to process the pre-shifted data 135 or the combined data 170 using a particular activation function. The particular activation function includes the NPOT quantization scheme and parametric ReLU function. More details of the particular activation function will be described below in connection with FIGS. 3A, 3B, and 3C. The quantization engine 150 is configured to generate quantized data 155 after processing the add-shifted data 145. The quantized data 155 is also referred to as nodal activations in the description below.

By using the NPOT quantization scheme, system 100 can map values (e.g., values of the pre-shifted data 145 or the add-shifted data 145) to a value range of a pre-determined data type based on a power that is not a multiple of two, e.g., a scale value that is greater than or equal to one and less than two. Accordingly, the NPOT quantization scheme allows the quantization engine 150 to maximize the usage of resolution of a pre-determined data type, which improves efficiency and reduces the memory usage of performing operations of neural networks. As an example of pre-shift operations, the system can remove up to 12 lower digits (or bits) of a data structure. For an input stored in INT24, the output after the pre-shift operations can be INT12.

As an example for illustrating the NPOT quantization scheme, system 100 can process an input of INT12 from the pre-shift operations to generate an output of INT13. System 100 first determines a maximum value in the set of values to be quantized. Assuming the maximum value in this example is 1303 stored in the data structure of INT12, the system can map the value of 1303 to the upper boundary of the INT12, which is 2047. The system can determine the NPOT parameter by dividing 2047 by 1303, which results in a floating number of 1.57099.

Furthermore, the system 100 rounds the floating value of the NPOT parameter into an integer data structure using the rounding techniques described herein. For example, the system 100 rounds up the floating value of the NPOT parameter by multiplying 1.57099 with 128 to obtain an integer of 201. The system stores the value of 201 to approximate the actual floating value of the NPOT parameter. Note that system 100 still uses the INT13 data structure for outputs so that system 100 can capture intermediate results exceeding the INT12 boundary values. For example, when the maximum value in the data set determined by the system (or a user) is not the real maximum value, by using a data structure with one more bit size, the system 100 can capture those overflowing values.

System 100 can use an 8-bit data structure to store the NPOT parameter value where the first bit represents the integer value of one, and the seven bits represent the decimal values. That said, since the NPOT parameter here is always greater than one, the system can subtract one from the actual NPOT parameter (e.g., 1.57099) to reduce the memory bandwidth needed for storing the NPOT parameter. By doing so, the system can store the NPOT parameter by using only 7 bits instead of 8 bits. In this example, system 100 stores the value of 73 instead of 201 in the registers, and when the operations call for the NPOT parameter value, system 100 then adds 128 and 73 together to obtain 201 and uses 201/128 to approximate the floating value of the NPOT parameter. Note that the above-described NPOT parameter is also referred to as the first coefficient associated with the NPOT scheme in the following description.

For input with the maximum value of 1303, the system can generate an output with a value of 2046, obtained by 1303*201/128 and roundup. If the input has a value different from the maximum value, e.g., 100, the system can obtain an output with a value (e.g., 157) by multiplying the input (e.g., 100) by 201/128.

The corresponding examples of post-shifting operations are described below. In addition, more details of the NPOT quantization scheme are described below in connection with FIGS. 3A, 3B, and 3C.

System 100 includes a post-shift engine 160 configured to process quantized data 155 to generate output data 180. Operations performed by the post-shift engine 160 is similar to those performed by the pre-shift engine 120. More specifically, the post-shift engine 160 is configured to reduce the data size or precision of the quantized data 155 by removing the lower bits of the data types used to store the quantized data 155. For example, the quantized data 155 can be stored in a data type of INT13, and the post-shift engine 160 can remove the lower 5 bits of the INT13 data type to generate an output stored in INT8. The operations performed by the post-shift engine 160 can also be referred to as the standard quantization operations using a power of two or the multiples of two. Similar to those discussed above, the post-shift operations do not include operations related to the NPOT quantization scheme and the parametric ReLU function.

To generate the output data 180, the post-shift engine 160 is further configured to perform a round operation to round up values greater than 0.5 in the least significant digit. In addition, similar to pre-shift engine 130, post-shift engine 160 is also configured to perform a clip operation to change values located outside the reduced range to a corresponding boundary value of the reduced range. For example, if a rounded-up value falls outside the representable range of [−128, 127], e.g., 128, the post-shift engine 160 is configured to change the value of 128 to 127, which is the boundary value closest to 128. The post-shift engine 160 is configured to provide the group of values as output data 180. As another example, for a value of −130 that falls outside the range of [−128, 127], the post-shift engine 160 is configured to change the value of −130 to −128, which is the boundary value closest to −130. More details of operations performed by the post-shift engine 150 are described below in connection with FIG. 4.

In addition, system 100 can be communicatively coupled with a memory unit 190. Memory unit 190 can be local or remote to quantization system 100. In some cases, memory unit 190 is generally configured to store parameters for quantization system 100. For example, memory unit 190 can store model parameters (e.g., nodal weights) for the neural network. Memory unit 190 can also provide these stored parameters to system 100 for performing neural network operations. In addition, the memory unit 190 can further store parameters for the NPOT quantization scheme and the parametric ReLU function and provide these parameters for system 100 to perform pre-shift and post-shift operations. The memory unit 190 is further configured to store data indicating the location of the decimal point and/or the exponential data for quantization. In some implementations, the memory unit 190 may optionally be configured to store and provide input data 110 to system 100, or temporarily store output data 180 (e.g., as a buffer), or both.

System 100 can be communicatively coupled to a server 195. Server 195 generally receives user requests for processing input data 110 using quantization system 100. In some cases, server 195 can receive and further process output data 180 to use the output generated by the neural network. In some cases, server 195 can generate instructions that, once executed by the quantization system 100, can turn on or off the NPOT quantization scheme and the parametric ReLU function using a global parameter and cause system 100 to process the input data 110 with/without the NPOT quantization scheme or the parametric ReLU function, or both.

FIG. 3A illustrates an example activation function 300 using a particular quantization scheme and the parametric ReLU function. As shown in FIG. 3A, the activation function 300 is formulated as follows.

$$f ( x ) = \{ \begin{matrix}ax , & x > 0 \\ cx , & otherwise\end{matrix} , \qquad Equation ( 1 )$$

where x represents a value to be processed by a nodal activation function, and the output ƒ(x) represents the nodal output for the corresponding node, where a is a first coefficient associated with the NPOT quantization scheme and a∈[1,2), and where c is a second coefficient associated with the parametric ReLU function and c∈[0, 2). In fact, the second coefficient c is determined based on the value of the first coefficient a, i.e., c=a*b, where b is the coefficient for a standard parametric ReLU function represented as follows.

$$f ( x ) = max ( bx , x ) where 0 \leq b \leq 1. \qquad Equation ( 2 )$$

Note that the value of b can be 0 or 1. Note also that the value of c can be zero but not two. For example, if b is 0.1 and a is 1.57099, as described above, coefficient c then has a value of 0.157099, which can be stored by the system 100 in an 8-bit data structure. For example, the system 100 can multiply the floating value of c by 128 and store the value of 20 in an integer data structure. The system 100 can approximate the value of c through dividing 20 by 128. Thus, the system 100 can generate an output value for a negative input value by multiplying the negative input value with 20/128. For example, for an input value of −100, the output value can be determined by −100 multiplies (20/128) to obtain the value of −16. For situations where the value of b is 1, i.e., a=c, the output is −157 for multiplying an input of −100 by (201/128).

In addition, Equation (1) further defines a threshold value y₁ such that when ƒ(x)>y₁, set ƒ(x)=y₁. In other words, the output value ƒ(x) is capped as the threshold value y₁. Note the threshold value is different from the cut-off operations described above.

The activation function 300 represents the NPOT quantization scheme and the parametric ReLU function, as described above. The additional multiply operations introduced to the original operations of the neural network are multiply operations between the first coefficient a and the values x, and the multiply operations between the second coefficient c and the values x. Although the additional multiply operations increase the total number of operations, multiply operations require less computation power than and are thus preferable to add operations, and the overall computation cost and memory usage are reduced due to the pre-shift operations and the NPOT quantization scheme. In addition, since the parametric ReLU function has non-zero first-order derivates for all x, the overall convergence in training the neural network is also improved.

As shown in FIG. 3A, the activation function 300 has three sections, i.e., section I (310), section II (320), and section III (330). Section I (310) generally refers to the portion where x is greater than zero. In section I (310), the activation function 300 has a slope defined by the first coefficient a, which is greater than (or equal to) 1 and smaller than 2. Section I (310) generally relates to the NPOT quantization since the mapping between the value x and nodal output y are in accordance with the first coefficient a. Section II (320) generally refers to the portion in the third quadrant where x is less than or equal to zero. The second coefficient c is non-zero and related to the parametric ReLU function, as described above. Section III (330) generally refers to the portion where ƒ(x) is cut off at y₁ for all ƒ(x) greater than the threshold value y₁.

By adjusting the first coefficient a and/or the second coefficient c, system 100 (or the pre-shift engine 130 and/or post-shift engine 150) can turn on and off the NPOT quantization and parametric ReLU function. In some implementations, system 100 can further include one or more global parameters configured to turn on and off the NPTO quantization scheme and the parametric ReLU function.

FIG. 3B illustrates an example non-power-of-two (NPOT) quantization scheme 240 derived from the example activation function of FIG. 3A. As shown in FIG. 3B, by setting the first coefficient a to equal the second coefficient c, the parametric ReLU function can be turned off such that the system 100 (or the quantization engine 150) only performs the NPOT quantization scheme 340. The system 100 can further implement a threshold value y₁ to cap output values for ƒ(x) greater than the threshold value y₁.

Moreover, FIG. 3C illustrates an example standard ReLU function 380 derived from the example activation function of FIG. 3A. As shown in FIG. 3C, by setting the first coefficient a to equal to one, equation (1) is formulated as follows.

$$f ( x ) = \{ \begin{matrix}x , & x > 0 \\ bx , & otherwise\end{matrix} . \qquad Equation ( 3 )$$

The derived function ƒ(x) of Equation (3) is, in fact, the standard parametric ReLU function 380, where 0≤b≤1, i.e., Equation (2). The system 100 can further implement a threshold value y₁ to cap output values for ƒ(x) greater than the threshold value y₁.

Accordingly, the described NPOT quantization scheme and the parametric ReLU function can be readily turned on and off by tuning the first and/or the second coefficients. Thus, the described NPOT quantization scheme and the parametric ReLU function performed by system 100 and the corresponding engines of system 100 are dynamic and robust to different requirements of performing the operations of a neural network.

FIG. 4 illustrates an example sequence of operations 400 performed by the example quantization system 100 of FIG. 1.

The system 100 receives computation results 430 as input data. The computation results in 430 include one or more multiplication results between the output from the previous layer 410 and the corresponding weight(s) for the current layer 420. The corresponding weight(s) can represent the nodal weight(s) of one or more nodes for the current layer. The corresponding weight(s) can be stored in different data structures, e.g., a scalar, vector, matrix, or other suitable data structures. The computation results 430 are generally computed by multiplying the output from the previous layer 410 and the corresponding weight(s) for the current layer 420 and, in some cases, summing the multiplication results. In these situations, the computation results 430 are generally stored in data types with a greater size or higher precision than output from the previous layer 410 and the weight(s) for the current layer 420. For example, the computation results 430 can be stored by the INT16 or INT24 data type when output from the previous layer 410 and the weight(s) for the current layer 420 are stored in the INT8 or UINT8 data type.

In some implementations, the system 100 directly receives output from the previous layer 410 and the weight(s) for the current layer 420 as input data, as described above. In these cases, the output from the previous layer 410 and the weight(s) for the current layer 420 can be received using the data type as the output data 490, e.g., INT8 or UINT8.

System 100 (or the bias engine 120) is configured to perform one or more bias operations 440 over the computation results 430. As described above, system 100 is configured to determine whether to bias the computation results 430 according to one or more criteria. The one or more criteria include at least one of whether the value distribution of the computation results 430 is roughly symmetric about an axis or whether the mean or median of the value distribution of the computation results 430 is equal to zero. To bias the computation results 430, system 100 adds or subtracts from the computation results 430 a bias value, which is determined according to the value distribution of the computation results 430 and stored in the same data size or with the same precision, e.g., INT16 or INT24. As described above, bias operations 440 can improve the utilization of the resolution of data types for representing data with a particular value range. More details of the value distribution and bias operations are described above.

System 100 (or the pre-shift engine 130) is configured to perform one or more pre-shift operations 450. The pre-shift operations 450 generally include operations to reduce the data size or precision of the biased data from the bias operations 440. For example, the pre-shift operations 450 relate to removing lower bits of the data type that stores the biased data so that the pre-shift is one or more bits smaller than that of the biased data. The output data generated from the pre-shift operations can have a size of 12 bits and be stored in, e.g., INT12.

In general, the pre-shift operations 450 do not include operations for performing the NPOT quantization scheme and the parametric ReLU function, as described above. However, pre-shift operations 450 can be referred to as a standard quantization scheme that uses powers of two. System 100 can store the instructions for performing pre-shift operations 460 using a 4-bit register, which can be used to determine the number of lowest bits of a 24-bit data structure to be removed, which is up to 12 bits.

The pre-shift operations 450 can include a clip operation 455 to change values that fall outside the range of the reduced resolution from the NPOT quantization scheme. The clip operation generally includes determining whether a value falling outside the reduced resolution is an outlier value. In response to determining that the value is an outlier value, system 100 can change the outlier value to one of the two boundary values of the reduced resolution that corresponds to the outlier value. For example, if the outlier value is greater than the greater of the two boundary values, system 100 changes the outlier value to the greater of the two boundary values. As another example, if the outlier value is smaller than the smaller of the two boundary values, system 100 changes the outlier value to the smaller of the two boundary values. System 100 provides the group of data as the output of the pre-shift engine 120.

After performing the pre-shift operations 450 and the clip operation 455, the system 100 is configured to perform operations of a particular activation function 465 to process intermediate results to generate quantized data or nodal activations. As described above, the particular activation function includes operations for the NPOT quantization scheme and nodal activation operations according to the parametric ReLU function. The NPOT quantization scheme and parametric ReLU function can be expressed as Equation (1). By setting different values for the first and second coefficients, and/or setting different values for one or more global parameters, system 100 can turn on and off the NPOT quantization scheme and/or the parametric ReLU function, and even transform the parametric ReLU function to a standard parametric ReLU function or a leaky ReLU function.

The NPOT quantization scheme generally relates to a quantization scheme using a scale factor other than the powers of two, in contrast to the standard quantization operations using scale factors of the powers of two. By implementing the NPOT quantization scheme, system 100 can more efficiently use data types to represent values (e.g., input data 110 of FIG. 1 or the computation results 430) since the NPOT quantization can further improve the utilization of the full resolution. In addition, the parametric ReLU function can further improve the efficiency by enhancing the convergence using a non-zero slope value for negative inputs.

The instructions for performing the NPOT quantization scheme can be stored in a 7-bit register. More specially, since for NPOT quantization, the first coefficient a is greater than 1. Accordingly, system 100 can subtract 1 from the first coefficient a and use 7 bits to store the decimal values of the first coefficient (a−1). System 100 is configured to use 8 bits to store the decimal values of the second coefficient c. Note that both the values of a and c can be stored in 7 bits for representing corresponding decimal digits.

In some implementations, the system 100, according to the topology of the neural network, needs to combine the nodal multiplication results of the current network layer and the output (or the intermediate result) of another network layer before performing the operations of the particular nodal activation function. In these situations, system 100 first performs an add-shift operation 460 to the output or intermediate computation result of another layer 457 to align the decimal point with that of the pre-shifted data from the current network layer. The instructions for the add-shift operation can be stored in a 2-bit register such that the instructions can specify whether to move the decimal point to 1 bit, 2 bits, 3 bits, etc. or not to move the decimal point at all. More details of the add-shift operations 460 are described below in connection with FIG. 5.

After aligning the decimal points of the computation results from different network layers, system 100 performs the add operations 463 to sum the pre-shifted data with the add-shifted data to generate combined data, as described above. The combined data generated from the add operations 463 is then processed by system 100 using the operations of the particular activation function 465, as described above.

In some implementations, system 100 can add the computation result from the other layer 457 with the output data that has been processed by the operations of the particular activation function, according to the different topologies of the neural network.

System 100 is further configured to perform post-shift operations 470. Post-shift operations 470 are similar to pre-shift operations 450 since post-shift operations 470 are performed by system 100 to further reduce the data sizes required. For example, the post-shift operations can further reduce the size from a 12-bit data structure to an 8-bit data structure (e.g., INT8 or UINT8). The instructions for the post-shift operations 470 can be stored in a 3-bit register.

Post-shift operations 470 further include a round operation 475 and a clip operation 480. System 100 is configured to perform a round operation 475 to round up values greater than 0.5 in the least significant digit. If a value is rounded up to fall outside the resolution determined by the post-shift operations, system 100 can clip the rounded-up result to one of the two boundaries of the data type. For example, if a value is quantized to 127.6 and rounded up to 128 for a resolution of [−128, 127] by a signed INT8 integer, the system can change the rounded-up value 128 to 127 so that the rounded-up data is clipped back to the right boundary of INT8.

Clip operation 480 is similar to clip operation 455 performed in the pre-shift operations 450 except that in addition to determining and changing outlier values from the original group of data, clip operation 480 further includes changing roundup values that fall outside the resolution.

The output from the post-shift operations 470 is also referred to as candidate layer output for one or more nodes in the current layer. System 100 is configured to perform cut-off operations 480 for the candidate layer output. The cut-off operations 480 generally relate to the threshold value y₁ defined in Equation (1). As described above, system 100 can determine whether the candidate layer output is greater than the threshold value y₁, and generate the layer output by setting the candidate layer output to the threshold value y₁ in response to determining that the candidate layer output is greater than the threshold value y₁.

FIG. 5 illustrates an example inter-layer structure of a neural network 500 that includes one or more add channels 510 and 540. The operations shown in FIG. 5 can be performed by a system implementing the described techniques. For example, system 100 of FIG. 1, when properly programed, can perform the operations in FIG. 5.

As shown in FIG. 5, the neural network 500 includes an add layer and a conv layer. The add layer includes a copy channel 530 and an add channel 540. The conv layer includes an add layer 510 and an insert channel 520. As described above, the system 100 combines output of the add channels 540 and 510 and then performs the operations defined by the particular activation function 555 over the combined data. More specifically, system 100 performs the shift one bit 543 operation to shift the output of add channel 510 by one bit to reduce the data size from 12 bits (e.g., INT12) to 11 bits (e.g., INT11). This is because the add operations 550 of data from two add channels 510 and 540 will increase the data size by one bit. System 100 performs the add-shift operations 545 to determine whether and how to move the decimal points of the data output by add channel 540, as described above. For example, system 100 can move the decimal point by three digits to change the data size from 8 bits (e.g., INT8) to 11 bits (e.g., INT11). The system 100 then performs the add operations 550 to combine the data from add channels 510 and 540. The output after system 100 performs the add operations 500 is 12 bits (e.g., INT 12). Next, system 100 performs operations of a particular activation function 555, post-shift operations 560, and cut-off operations 565 sequentially in a fashion similar to those described above to generate output for add channel 585 of the output layer. The output for add channel 585 can be stored using 8 bits (e.g., INT8.)

System 100 also performs the shift one bit 547 operations to shift the output of insert channel 520 by one bit to reduce the data size from 12 bits (e.g., INT12) to 11 bits (e.g., INT11). Next, system 100 performs operations of a particular activation function 557, post-shift operations 563, and cut-off operations 567 sequentially in a fashion similar to those described above to generate output for insert channel 590 of the output layer. The output for insert channel 590 can be stored using 8 bits (e.g., INT8.)

System 100 performs power of two quantization 570 to process the output data of copy channel 530, and then performs standard ReLU operations 573 to generate nodal output. System 100 then provides the nodal output to the copy channel 580 of the output layer.

In some implementations, system 100 can determine whether a data type of the nodal output from one or more of the above-noted channels (e.g., copy channel 530, add channels 540 and 510, and insert channel 520) is different from a native data type supported by the corresponding computation unit assigned for the computations. In response to determining that the data type of nodal output is different from the native data type, system 100 is configured to change the data type of the nodal output to the native data type before providing the data as output to the corresponding channels in the output layer. For example, system 100 can determine that the native data type for the nodal output layer supported by the corresponding computation unit is stored in an unsigned integer formatting (e.g., UINT8), whereas the intermediate computation results for performing operations of the current conv layer (and optionally the add layer) are stored in the native data type (e.g., INT8). In response, system 100 can change the data type of the nodal output to the unsigned integer formatting (e.g., UINT8) before providing the nodal output as the output of corresponding channels of the output layer.

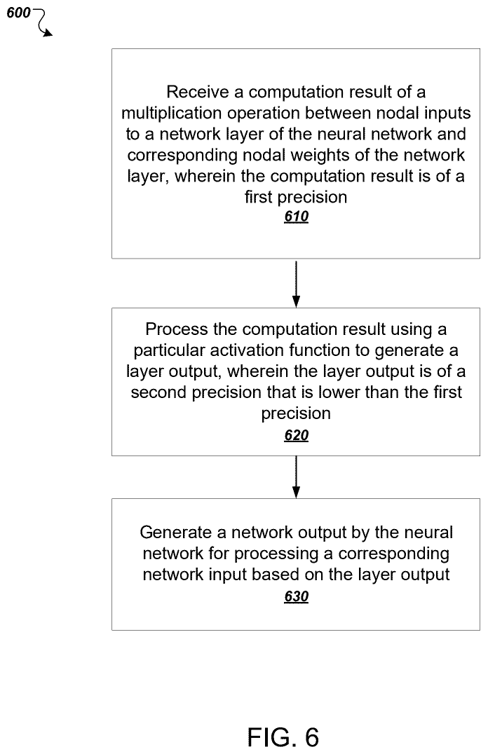

FIG. 6 is a flow diagram of an example process 600 for processing input data using a particular activation function. For convenience, the example process 600 is described as being performed by a system of one or more computers located in one or more locations. For example, the quantization system 100 of FIG. 1, when appropriately programmed, can perform the process 600.

In general, the system can perform operations represented by a neural network. The neural network includes multiple neural network layers. Each layer includes one or more nodes, and each node is associated with one or more nodal weights and a respective nodal activation function.

The system receives a computation result of a multiplication operation between nodal inputs to a network layer of the neural network and corresponding nodal weights of the network layer (610). The computation result can be a scalar or vector and can represent a portion of nodal operations of the current network layer. The computation result is of a first precision that is higher than the precision for storing the nodal inputs and nodal weights. For example, the nodal inputs and nodal weights can be stored in a data type with a size of 8 bits (e.g., INT8 or UINT8), and the computation results can be stored in a data type with a size of 16 bits or 24 bits (e.g., INT16 or INT24). Note that the computation result can be stored in other suitable data types or formatted according to different requirements of performing the operations of the neural network and/or different hardware designs.

The system processes the computation result using a particular activation function to generate a layer output (620). The layer output can be stored in a data type of a second precision that is lower than the first precision. For example, the second precision can have the same data size of nodal inputs and nodal weights (e.g., 8 bits or INT8). Note that the layer output can be stored in other suitable data types or formatted according to different requirements of performing the operations of the neural network and/or different hardware designs.

The particular activation function is determined based on a quantization process using a power value other than the multiples of two, and the particular activation function generates a non-zero output when the computation result is non-zero by using a parametric ReLU function. As described above, the activation function includes the NPOT quantization scheme, and the parametric ReLU function. In general, the system or corresponding engines in the system can perform operations following the particular activation function specified in Equation (1). The system can turn on and off the NPOT quantization scheme and/or the parametric ReLU function by adjusting the first and second coefficients of Equation (1). In some implementations, the system can use a global parameter to turn on and off the NPOT quantization scheme and/or the parametric ReLU function. The system can further derive other ReLU functions from Equation (1) by adjusting the first and second coefficients.

Before processing the computation result using a particular activation function to generate the layer output, the system first determines whether to perform a bias operation for the computation result according to one or more criteria. The one or more criteria include at least one of whether the value distribution of the computation result is roughly symmetric about an axis or whether the mean or median of the value distribution of the computation result is equal to zero. In response to determining to perform a bias operation for the computation result, the system generates a biased computation result by adding or subtracting a bias value from the computation result. The bias value is determined based on a value distribution of all possible computation results according to the nodal inputs and the corresponding nodal weights of the network layer.

The system further performs a pre-shift operation of the biased computation result to generate an intermediate result. The intermediate result is stored in a data structure with a third precision that is higher than the second precision and lower than the first precision. For example, the intermediate result can be stored using 12 bits (e.g., INT12) which has a precision higher than the second precision (of 8-bit data, e.g., INT8 or UINT8) and lower than the first precision (of 16-bit or 24-bit data, e.g., INT16 or INT 25). More details of the pre-shift operation are described above.

To perform the pre-shift operations, the system processes the biased computation result according to the particular activation function expressed in Equation (1), which includes a first coefficient a that defines the power value used in the NPOT quantization scheme and a second coefficient c defines a parametric ReLU function. The first coefficient a is greater than or equal to one and less than two, and the second coefficient c is greater than zero and less than or equal to one.

The system further performs a clip operation over the intermediate result. More specifically, the system determines whether the intermediate result satisfies a clip criterion. The clip criterion compares the resolution defined in the quantization process and the value of the intermediate result. In response to determining that the intermediate result satisfies the clip criterion, the system updates the intermediate result by performing a clip operation to set the value of the intermediate result to one of the corresponding boundary values defined in the quantization process. In some implementations, the system changes values that satisfy the clip criterion and adds new values of a corresponding one of the two boundary values defining the resolution range. After performing the clip operation, the system performs the operations specified by the particular activation function to generate nodal activations, as described above.

After performing the operations of the particular activation function, the system performs a post-shift operation over the nodal activations by further reducing the data sizes and/or precisions of the nodal activations to generate a candidate layer output. The post-shift operation is similar to the pre-shift operation. The candidate layer output can be represented by INT8, which is smaller in size than those representing the nodal activations, e.g., INT13.

The post-shift operation further includes a rounding operation. More specifically, the system performs a rounding operation to the last significant digit in the candidate layer output. If the last significant digit is greater than 0.5, the system rounds up the candidate layer output and clips the rounded-up data to the one of the two boundaries of the data type.

The system can perform the clip operation similarly to the candidate layer output. More specifically, the system determines whether the candidate layer output satisfies the clip criterion. The clip criterion compares the resolution defined in the quantization process and the value of the candidate layer output (or the roundup candidate layer output). In response to determining that the candidate layer output satisfies the clip criterion, the system updates the candidate layer output by performing the clip operation to set the value of the candidate layer output to one of the corresponding boundary values defined in the quantization process.

The system further performs a cut-off operation. More specifically, the system determines that the candidate layer output is greater than a threshold value and generates the layer output by setting the candidate layer output to the threshold value. Equation (1), as described above, determines the threshold value.

In some implementations, the system can perform an add-shift operation over output generated from one or more add-channels of a network layer. More specifically, the system receives another computation result of a multiplication operation between nodal inputs to another network layer of the neural network and corresponding nodal weights of the other network layer, where the other computation result has a fourth precision different from the first precision. For example, the other computation result can be stored in 8-bits (e.g., INT8). The system performs an add-shift operation over the other computation result such that the decimal point of the other computation result aligns with that of the computation result generated by the current layer. After aligning the decimal points, system 100 adds the outputs from the other network layer and the current network, and the added result is further processed by system 100 using the operations defined by the particular activation function.

The system can store respective instruction data in one or more registers to process the computation result using the particular activation function to generate the layer output. For example, the one or more registers include at least 24 bits. The respective instruction data can include instruction data for a pre-shift operation stored in 4 bits, instruction data for an add-shift operation stored in 2 bits, instruction data for NPOT quantization stored in 7 bits, instruction data for parametric ReLU function stored in 8 bits, and instruction data for a post-shift operation stored in 3 bits.

The system generates a neural network output for a corresponding network input based on the layer output (630). For example, the network output can include a predicted sequence of text, audio, images, or other data to be used for perceiving traffic conditions. The network output can be further used to generate operations to control the operations of a self-driving vehicle on the road.

The term “machine learning model” throughout the specification stands for any suitable model used for machine learning. As an example, the machine learning model can include one or more neural networks trained for performing different inference tasks. Examples of neural networks and tasks performed by neural networks are described in greater detail at the end of the specification. For simplicity, the term “machine learning models” is sometimes referred to as “neural network models” or “deep neural networks” in the following specification.

Depending on the task, a neural network can be configured, i.e., through training, to receive any kind of digital data input and to generate any kind of score, classification, or regression output based on the input.

In some cases, the neural network is a neural network that is configured to perform an image processing task, i.e., receive an input image and process the input image to generate a network output for the input image. In this specification, processing an input image refers to processing the intensity values of the pixels of the image using a neural network. For example, the task may be image classification and the output generated by the neural network for a given image may be scores for each of a set of object categories, with each score representing an estimated likelihood that the image contains an image of an object belonging to the category. As another example, the task can be image embedding generation and the output generated by the neural network can be a numeric embedding of the input image. As yet another example, the task can be object detection and the output generated by the neural network can identify locations in the input image at which particular types of objects are depicted. As yet another example, the task can be image segmentation and the output generated by the neural network can assign each pixel of the input image to a category from a set of categories.

As another example, if the input to the neural network is a sequence of text in one language, the output generated by the neural network may be a score for each of a set of pieces of text in another language, with each score representing an estimated likelihood that the piece of text in the other language is a proper translation of the input text into the other language.

In some cases, the machine learning task is a combination of multiple individual machine learning tasks, i.e., the neural network is configured to perform multiple different individual machine learning tasks, e.g., two or more of the machine learning tasks mentioned above. For example, the neural network can be configured to perform multiple individual image processing or computer vision tasks, i.e., by generating the output for the multiple different individual image processing tasks in parallel by processing a single input image.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, e.g., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program which may also be referred to or described as a program, software, a software application, an app, a module, a software module, a script, or code) can be written in any form of programming language, including compiled or interpreted languages, or declarative or procedural languages, and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language specification, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

For a system of one or more computers to be configured to perform particular operations or actions means that the system has installed on it, software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

As used in this specification, an “engine,” or “software engine,” refers to a software implemented input/output system that provides an output that is different from the input. An engine can be an encoded block of functionality, such as a library, a platform, a software development kit (“SDK”), or an object. Each engine can be implemented on any appropriate type of computing device, e.g., servers, mobile phones, tablet computers, notebook computers, music players, e-book readers, laptop or desktop computers, PDAs, smart phones, or other stationary or portable devices, that includes one or more processors and computer readable media. Additionally, two or more of the engines may be implemented on the same computing device, or on different computing devices.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and pointing device, e.g., a mouse, trackball, or a presence sensitive display or other surface by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone, running a messaging application, and receiving responsive messages from the user in return.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

In addition to the embodiments described above, the following embodiments are also innovative:

Embodiment 1 is a method for performing operations represented by a neural network comprising a plurality of neural network layers, wherein the method comprises: receiving a computation result of a multiplication operation between nodal inputs to a network layer of the neural network and corresponding nodal weights of the network layer, wherein the computation result is of a first precision; processing the computation result using a particular activation function to generate a layer output, wherein the layer output is of a second precision that is lower than the first precision, wherein the particular activation function is determined based on a quantization process using a power value other than the multiples of two, and wherein the particular activation function generates a non-zero output when the computation result is non-zero; and generating a neural network output for a corresponding network input based on the layer output.

Embodiment 2 is the method of Embodiment 1, wherein processing the computation result using a particular activation function to generate the layer output comprises: performing a bias operation to generate a biased computation result by adding or subtracting a bias value to the computation result, wherein the bias value is determined based on a distribution of all possible computation results according to the nodal inputs and the corresponding nodal weights of the network layer.

Embodiment 3 is the method of Embodiment 2, wherein processing the computation result using a particular activation function to generate the layer output comprises: performing a pre-shift operation of the biased computation result to generate an intermediate result, wherein the intermediate result has a third precision that is higher than the second precision and lower than the first precision.

Embodiment 4 is the method of Embodiment 3, further comprising processing the intermediate result using the particular activation function to generate a nodal activation, wherein the particular activation function comprises a first coefficient associated with the power value used in the quantization process and a second coefficient associated with a parametric rectified linear unit (ReLU) function.

Embodiment 5 is the method of Embodiment 4, wherein the first coefficient is greater than or equal to one and less than two, and the second coefficient is greater than zero and less than or equal to one.

Embodiment 6 is the method of Embodiment 4 or 5, further comprising performing a post-shift operation of the nodal activation to generate a candidate layer output.

Embodiment 7 is the method of Embodiment 6, further comprising: determining that the intermediate result or candidate layer output satisfies a clip criterion, in response to determining that the intermediate result satisfies the clip criterion, updating the intermediate result by performing a clip operation to set the value of the intermediate result to one of corresponding boundary values defined in the quantization process, and in response to determining that the candidate layer output satisfies the clip criterion, updating the candidate layer output by performing the clip operation to set the value of the candidate layer output to one of the corresponding boundary values defined in the quantization process.

Embodiment 8 is the method of Embodiment 6 or 7, further comprising: performing a rounding operation to the last significant digit in the candidate layer output.

Embodiment 9 is the method of any one of Embodiments 6-8, further comprising: determining that the candidate layer output is greater than a threshold value, and generating the layer output by setting the candidate layer output to the threshold value.

Embodiment 10 is the method of any one of Embodiments 3-9, further comprising: receiving another computation result from another network layer of the neural network, wherein the other computation result is computed by multiplying nodal inputs to the other network layer of the neural network and corresponding nodal weights of the other network layer, wherein the other computation result has a fourth precision different from the first precision; and performing an add-shift operation to the other computation result such that a decimal point position of the other computation result aligns with a decimal point of the intermediate result.

Embodiment 11 is the method of any one of Embodiments 1-10, wherein the second precision is represented by an 8-bit integer.

Embodiment 12 is the method of any one of Embodiments 1-11, further comprising: storing respective instruction data in one or more registers for processing the computation result using the particular activation function to generate the layer output, wherein the one or more registers include at least 24 bits, and wherein the respective instruction data comprises (i) instruction data for a pre-shift operation stored in 4 bits, (ii) instruction data for an add-shift operation stored in 2 bits, (iii) instruction data for the quantization process stored in 7 bits, (iv) instruction data for a parametric ReLU function stored in 8 bits, and instruction data for a post-shift operation stored in 3 bits.

Embodiment 13 is a system comprising one or more computers and one or more storage devices storing instructions that when executed by one or more computers cause the one or more computers to perform respective operations, the operations comprising the method of any one of Embodiments 1-12.

Embodiment 14 is one or more computer-readable storage media storing instructions that when executed by one or more computers cause the one or more computers to perform respective operations, the respective operations comprising the method of any one of Embodiments 1-12.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain cases, multitasking and parallel processing may be advantageous.

1. A method for performing operations represented by a neural network comprising a plurality of neural network layers, wherein the method comprises:
receiving a computation result of a multiplication operation between nodal inputs to a network layer of the neural network and corresponding nodal weights of the network layer, wherein the computation result is of a first precision;
processing the computation result using a particular activation function to generate a layer output, wherein the layer output is of a second precision that is lower than the first precision, wherein the particular activation function is determined based on a quantization process using a power value other than the multiples of two, and wherein the particular activation function generates a non-zero output when the computation result is non-zero; and
generating a neural network output for a corresponding network input based on the layer output.

2. The method of claim 1, wherein processing the computation result using a particular activation function to generate the layer output comprises:
performing a bias operation to generate a biased computation result by adding or subtracting a bias value to the computation result, wherein the bias value is determined based on a distribution of all possible computation results according to the nodal inputs and the corresponding nodal weights of the network layer.

3. The method of claim 2, wherein processing the computation result using a particular activation function to generate the layer output comprises:
performing a pre-shift operation of the biased computation result to generate an intermediate result, wherein the intermediate result has a third precision that is higher than the second precision and lower than the first precision.

4. The method of claim 3, further comprising:
processing the intermediate result using the particular activation function to generate a nodal activation, wherein the particular activation function comprises a first coefficient associated with the power value used in the quantization process and a second coefficient associated with a parametric rectified linear unit (ReLU) function.

5. The method of claim 4, wherein the first coefficient is greater than or equal to one and less than two, and the second coefficient is greater than zero and less than or equal to one.

6. The method of claim 4, further comprising:
performing a post-shift operation of the nodal activation to generate a candidate layer output.

7. The method of claim 6, further comprising:
determining that the intermediate result or candidate layer output satisfies a clip criterion,
in response to determining that the intermediate result satisfies the clip criterion, updating the intermediate result by performing a clip operation to set the value of the intermediate result to one of corresponding boundary values defined in the quantization process, and
in response to determining that the candidate layer output satisfies the clip criterion, updating the candidate layer output by performing the clip operation to set the value of the candidate layer output to one of the corresponding boundary values defined in the quantization process.

8. The method of claim 6, further comprising:
performing a rounding operation to the last significant digit in the candidate layer output.

9. The method of claim 6, further comprising:
determining that the candidate layer output is greater than a threshold value, and
generating the layer output by setting the candidate layer output to the threshold value.

10. The method of claim 3, further comprising:
receiving another computation result from another network layer of the neural network, wherein the other computation result is computed by multiplying nodal inputs to the other network layer of the neural network and corresponding nodal weights of the other network layer, wherein the other computation result has a fourth precision different from the first precision; and
performing an add-shift operation to the other computation result such that a decimal point position of the other computation result aligns with a decimal point of the intermediate result.

11. The method of claim 1, wherein the second precision is represented by an 8-bit integer.

12. The method of claim 1, further comprising:
storing respective instruction data in one or more registers for processing the computation result using the particular activation function to generate the layer output,
wherein the one or more registers include at least 24 bits, and wherein the respective instruction data comprises (i) instruction data for a pre-shift operation stored in 4 bits, (ii) instruction data for an add-shift operation stored in 2 bits, (iii) instruction data for the quantization process stored in 7 bits, (iv) instruction data for a parametric ReLU function stored in 8 bits, and instruction data for a post-shift operation stored in 3 bits.

13. A system comprising one or more computers and one or more storage devices storing instructions that, when executed by one or more computers, cause the one or more computers to perform respective operations, the operations comprising:
receiving a computation result of a multiplication operation between nodal inputs to a network layer of a neural network comprising a plurality of neural network layers and corresponding nodal weights of the network layer, wherein the computation result is of a first precision;
processing the computation result using a particular activation function to generate a layer output, wherein the layer output is of a second precision that is lower than the first precision, wherein the particular activation function is determined based on a quantization process using a power value other than the multiples of two, and wherein the particular activation function generates a non-zero output when the computation result is non-zero; and
generating a neural network output for a corresponding network input based on the layer output.

14. The system of claim 13, wherein processing the computation result using a particular activation function to generate the layer output comprises:
performing a bias operation to generate a biased computation result by adding or subtracting a bias value to the computation result, wherein the bias value is determined based on a distribution of all possible computation results according to the nodal inputs and the corresponding nodal weights of the network layer.

15. The system of claim 14, wherein processing the computation result using a particular activation function to generate the layer output comprises:
performing a pre-shift operation of the biased computation result to generate an intermediate result, wherein the intermediate result has a third precision that is higher than the second precision and lower than the first precision.

16. The system of claim 15, the operations further comprise:
processing the intermediate result using the particular activation function to generate a nodal activation, wherein the particular activation function comprises a first coefficient associated with the power value used in the quantization process and a second coefficient associated with a parametric rectified linear unit (ReLU) function.

17. One or more computer-readable storage media storing instructions that, when executed by one or more computers, cause the one or more computers to perform respective operations, the respective operations comprising:
receiving a computation result of a multiplication operation between nodal inputs to a network layer of a neural network comprising a plurality of neural network layers and corresponding nodal weights of the network layer, wherein the computation result is of a first precision;
processing the computation result using a particular activation function to generate a layer output, wherein the layer output is of a second precision that is lower than the first precision, wherein the particular activation function is determined based on a quantization process using a power value other than the multiples of two, and wherein the particular activation function generates a non-zero output when the computation result is non-zero; and
generating a neural network output for a corresponding network input based on the layer output.

18. The one or more computer-readable storage media of claim 17, wherein processing the computation result using a particular activation function to generate the layer output comprises:
performing a bias operation to generate a biased computation result by adding or subtracting a bias value to the computation result, wherein the bias value is determined based on a distribution of all possible computation results according to the nodal inputs and the corresponding nodal weights of the network layer.

19. The one or more computer-readable storage media of claim 18, wherein processing the computation result using a particular activation function to generate the layer output comprises:
performing a pre-shift operation of the biased computation result to generate an intermediate result, wherein the intermediate result has a third precision that is higher than the second precision and lower than the first precision.

20. The one or more computer-readable storage media of claim 19, the operations further comprise:
processing the intermediate result using the particular activation function to generate a nodal activation, wherein the particular activation function comprises a first coefficient associated with the power value used in the quantization process and a second coefficient associated with a parametric rectified linear unit (ReLU) function.
